(19) United States
(12) Patent Application Publication
(10) Pub. No.: US 2010/0061352 A1
(43) Pub. Date: Mar. 11, 2010

(54) METHOD FOR ROUTING TRAFFIC IN A LOCAL MOBILE COMMUNICATION NETWORK

(76) Inventors: Elena Fasolo, Padova (IT); Federico Maguolo, Padova (IT); Andrea Zanella, Padova (IT); Michele Zorzi, Padova (IT); Simone Ruffino, Torino (IT); Patrick Stupar, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/312,179

(22) PCT Filed: Oct. 31, 2006
(86) PCT No.: PCT/EP2006/010465

§ 371 Date: Nov. 19, 2009

(51) Int. Cl. H04W 40/00; H04L 12/66

(52) U.S. Cl. 370/338; 370/352

(57) ABSTRACT

A method for routing VoIP traffic in a local mobile communication network includes selecting a path among a set of possible paths between two nodes of the network based on the number of hops and the transmission time of a reference voice packet along the possible paths, the transmission time along each path being a function of the transmission rates associated with the links composing the path.

### FIELD OF THE INVENTION

The present invention relates to a method for routing communication traffic in a local mobile communication network, in particular in a wireless

Mobile Ad-hoc Network (MANET), more in particular to a MANET connected to an external network by means of a gateway.

### DESCRIPTION OF THE RELATED ART

MANETs are wireless networks characterized by the absence of any infrastructure: nodes of a MANET operate both as hosts (i.e. they are end-points of a communication) and as routers. In fact packets that cannot be directly delivered between two nodes are routed through other intermediate nodes following a multi-hop path to reach their destination.

Routing within a MANET is enabled by a routing protocol, which runs on every MANET node: by exchanging control messages, the MANET nodes can calculate the routes (or “paths”) towards other nodes and choose the optimal one (i.e., the “best path”) with respect to the used metric. Nodes typically own a unique identifier, which is used for routing purposes and/or data exchange.

A MANET can be an isolated network or can be connected to an external network through one or more nodes that act as gateway. The gateway is a MANET node that is equipped with at least another interface allowing communication with the external network. The gateway can forward traffic from one interface to another, thus bridging the corresponding networks.

If nodes belonging to the MANET run the Internet Protocol (IP) and the MANET is connected to an external IP network (e.g. the global Internet), global connectivity has to be guaranteed, i.e. each MANET node has to be identified by a valid IP address that is necessary to receive packets transmitted by hosts located outside the MANET.

A number of MANET routing protocols has been proposed by the Internet Engineering Task Force (IETF). These protocols use the “hop-count” as routing metric, i.e. the number of hops between the source node and the destination node. In particular, the path to the gateway computed according to this metric will be used to send packets to hosts located in the external network.

The Optimized Link State Routing (OLSR) protocol is one of these MANET routing protocol. OLSR is a “proactive” routing protocol: this means that control messages containing topological information of the MANET are periodically generated and transmitted by each node belonging to the MANET. By means of such broadcast information each MANET node can know a path towards every other MANET node (i.e. the complete topology of the network).

MANET nodes can instantiate connections with remote peers, located in external networks. The traffic originated by a mobile node of the MANET (Uplink) is first delivered to the gateway by using one multi-hop connection in the MANET. The gateway then relays the traffic to the external network, which is expected to deliver the data to the intended peer. The return flow (Downlink), in turn, is first delivered by the external network to the gateway and, hence, relayed to the destination MANET node through a multi-hop path within the MANET.

Reference will be made in the following to the IEEE 802.11 standard (or Wi-Fi standard): this denotes a set of Wireless LAN/WLAN standards developed by working group 11 of the IEEE LAN/MAN Standards Committee (IEEE 802). The MANET here considered are a kind of network compliant with the IEEE 802.11 specifications.

The IEEE 802.11 protocol may use the Distributed Coordination Function (DCF) to share the communication medium between multiple stations. If the nodes of the MANET use IEEE 802.11 with DCF channel access mode, and if connections instantiated by MANET nodes present a constant bit-rate, below 64 kbps, and a packet size below 60 bytes (like in Voice over IP traffic), the gateways represent the bottleneck of such an architecture. In fact, the large amount of small packets generates congestions in proximity of the gateways and on gateways themselves.

Some previous works reported estimations of the voice capacity of an IEEE 802.11 cell, i.e., the maximum number of voice flows that can be supported through a single access point. A main characteristic of voice packets is that they have a small payload size, and this strongly affects the network efficiency.

S. Garg and M. Kappes, in “Can I add a VoIP Call?”, Proceedings of IEEE ICC, Anchorage, 11-15 May 2003, determined the voice capacity of an IEEE 802.11b cell, under Distributed Coordination Function (DCF) scheme, for several codecs. Analysis shows that the system is capable of supporting up to 6 VoIP connections using G.711 codec (64 kbps) and up to 7 using G.729 codec (8 kbps), when the duration of the voice sample (payload) is 10 ms and all terminals transmit at the maximum physical rate of 11 Mbps (nominal bitrate of an IEEE 802.11b based WLAN). It can be observed that, in both cases, the aggregate voice traffic is 2 orders of magnitude smaller than the physical rate, which implies low efficiency. The same document discloses a way to calculate the transmission time of a voice packet: the on-air transmission time T_{w} of a MPDU at a rate Rⱼ can be expressed as:

T_{W}=TₚT_{layers}+T_{SIFS+ACK+DIFS}

where Tₚ is the transmission time of a voice packet of size p over 802.11, T_{layers} is the transmission time of physical and MAC portions of the packet, and T_{SIFS+ACK+DIFS} is the transmission time of the Acknowledgment packet combined with that of the Short and DCF Inter-Frame Space.

Throughput and delay performance of multi-hop ad hoc connections have been extensively studied since many years and a number of methods for optimizing transmission of IP traffic over a multi-hop network have been proposed.

In U.S. Pat. No. 7,058,021 B2, the authors propose a solution enabling nodes of an ad-hoc network to discover a gateway and select a path towards it. The proposed algorithm uses periodical beacons generated and transmitted by gateways to the network. Each beacon contains the address of the gateway that has generated it, a counter and optionally a traffic monitoring code

(TMC). After receiving a beacon, each node establishes the quality of the link through which such beacon has been received: if the quality is considered acceptable, the node elects the neighbor (on that link) as next hop to use to send messages to the gateway and retransmits the beacons, after having incremented the counter and having inserted its traffic monitoring code. Each retransmitted beacon contains the list of the MTCs of intermediate nodes of the path between the gateway and the node itself and the number of intermediate nodes.

The same patent proposes several algorithms to evaluate the quality of the link: the reference one is based upon the ratio between the successfully received beacons and the transmitted one along an established period (the ratio must be greater than a predefined threshold), but other metrics such as traffic congestion and latency are cited. When a node receives beacons from several neighbors, it chooses the neighbor whose emitted beacon contains the lower value in the counter. If after such choice there are more candidate neighbors for the election, authors propose several criteria of election of the next hop towards the gateway: the quality of the link, the number of hops contained in the beacon, the instant the beacon has been received (the first heard beacon is considered) and the evaluation of the TMCs listed. This procedure enables a node to calculate a path towards a gateway: the reverse path (from the gateway to the node) is obtained by the gateway through a reverse beacons transmitted by each node towards its correspondent selected neighbor.

US 20060002368 A1 proposes a solution for sensor networks aimed at reducing the overlapping paths set-up by sensor devices and at using optimal paths with respect to a defined metric. The provided definition of overlapping path is the following: two paths are overlapping when they share the same infrastructure node (i.e. the gateway in the present embodiment). Optimal non-overlapping paths are calculated by a centric entity by considering routing information collected from the set of infrastructure nodes.

The article of B. Auerbuch, D. Holmer, H. Rubens, “High Throughput Route Selection in Multi-rate Ad Hoc Wireless Networks”, First Working Conference on Wireless On-demand Wireless Systems (WONS), 2004, describes a metric based upon rates assigned to links by 802.11. Each link owns a weight derived by the rate associated to the link (the higher the rate, the lower the weight): routing protocol calculates the paths by applying the Dijkstra algorithm to the topology with the weighted links. Authors affirm that their proposed solution aims at optimizing achievable throughput and is not suitable for delay sensitive traffic, which is affected by the number of traversed buffers, i.e. the number of hops of the traversed path. Authors propose to use a priority queuing approach to cope with this problem for this kind of traffic.

### SUMMARY OF THE INVENTION

The Applicant notes that the above-mentioned prior art documents refer to very generic network topologies, where communication can occur between any pair of nodes in the MANET, that can send and receive any traffic type, with no specific shape. These documents don't consider the problem of enlarging the number of sustainable sessions when the data transmissions are directed from multiple sources of a MANET to a single or few destination (gateways in our cases) of the same MANET and the transmitted traffic has specific characteristics, such as small packets at lower rates, in particular when it is Voice over IP traffic.

In particular, the Applicant notes that the procedure described in U.S. Pat. No. 7,058,021 B2 introduces a delay due to the fact that the two directional paths to the gateway are built separately, in other words a latency is introduced since the bidirectional path required to establish VoIP communications is built in two steps: the first one is required to build the path from the node to the gateway and the second one is necessary for the path in the opposite direction.

Regarding the solution described in US 20060002368 A1, the Applicant observes that it requires a central entity, which is an additional point of failure of the system. The Applicant also notes that there is no mention in this document to the link rate as a parameter to be considered in the metric. Moreover, if there is a single infrastructure node in the scenario (such as the single gateway in the reference scenario), no need of overlapping paths is required.

For what concerns the solution described in B. Auerbuch, D. Holmer, H. Rubens, “High Throughput Route Selection in Multi-rate Ad Hoc Wireless Networks”, the Applicant notes that queuing approach is unsuitable for practical application since it requires a substantial modification to the firmware of the wireless interface of the nodes.

Moreover, known routing protocols that use only the hop-count as the routing metric minimize the number of hops of each path but don't minimize the delivery delay. The Applicant further notes that the above-mentioned routing protocols have no means to choose among paths that have the same length, but different radio characteristics. In particular, the Applicant notes that the route selection performed by the AODV (Ad-hoc On-demand Distance Vector) protocol (see “Ad-hoc On-demand Distance Vector Routing Protocol”, RFC3561, C. Perkins, E. Belding-Royer, S. Das) depends on the traffic conditions and on the delivery of the route requests and route response messages: in fact, AODV could select a better path only because it has lost one or more routing packets.

The Applicant has sought a routing solution for improving communication in a local mobile communication network such as a MANET, in particular for improving communications between a MANET and an external network, which are typically affected by a bottleneck effect at the gateways.

The Applicant has preliminarily analyzed the VoIP traffic capacity in case that all terminals are in the coverage range of the gateway (single-cell): the analysis has revealed that, in presence of multi-rate terminal, the capacity of the system is limited to 8 connections, which reduces to 7 when some terminals are mutually hidden.

The Applicant has also analyzed the VoIP traffic capacity when source nodes need to establish a multi-hop connection to reach the gateway. In this case, the Applicant has discovered that the number of sustainable connections halves with respect to the single hop case and that the routing protocols and the number of hops in each path have a strong impact on the voice capacity of the system.

An object of the present invention is therefore that of providing a routing method that is not affected by the problems of the known prior art and that is able to increase the system capacity, in particular when communication is directed to a single point in the MANET.

The present invention aims at minimizing the length of the paths, taking into consideration the radio characteristics of the links of the available paths. According to the invention, a new metric is introduced, to be used by the routing protocol, which takes into account the hop-count towards the destination, together with the on-air time needed for a reference packet to traverse the path to reach the destination. The two parameters are properly weighted so that nodes prefer the shortest path and, in case of multiple paths with same length, nodes prefer the fastest path. This new metric allows to improve the system capacity of a MANET, in particular in communications with external networks through a gateway.

Moreover, nodes can have more paths to choose among to reach the gateway, with respect to the number of paths the known prior art solutions can provide. In particular, being the criterium of path selection deterministically bound to the spatial distribution of nodes (because the transmission rate depends upon the distance between nodes) the probability that traffic is evenly distributed among nodes that are one-hop away from the gateway increase, and the probability of nodes congestion diminishes accordingly. An addition advantage is that nodes can set-up bi-directional paths with no delays. The technique of the present invention is distributed, in that it separately runs on each node and does not require any centric entity and it is independent from the load conditions on the nodes.

Although the present invention has been conceived in particular for communications (in particular VoIP) between a MANET and an external network, the same technique is advantageous for communications within the MANET.

According to a first aspect thereof, the present invention thus relates to a method for routing VoIP traffic in a multi-hop mobile communication network, comprising selecting a path among a set of possible paths between two nodes of said network based on the number of hops and the transmission time of a reference voice packet along the possible paths.

Preferably, each of the possible paths is composed of one or more links, each link connecting two neighbour nodes and having associated a respective transmission rate; the transmission time along each possible path being a function of the transmission rates associated to the links composing the path.

The step of selecting a path preferably comprises assigning a cost to each of the possible paths, the cost being related to the number of hops and the transmission time through a first and a second weight, respectively.

Preferably, the method comprises selecting the first and the second weight so that if the set of possible paths includes a path with a lowest number of hops, the selected path is that path.

Moreover, the method preferably comprises selecting the first and the second weight so that if the set of possible paths includes two paths with a lowest number of hops, the selected path is the one of such two paths having the lowest transmission time.

Preferably, each of the links is associated with an elementary cost related to the respective transmission time, and the cost assigned to each of the possible path is the sum of the elementary costs of the links of the path.

The cost may be expressed by the following equation:

W=Σᵢ(α+β·tᵢ)

wherein i is the number of links in the path; α is said first weight; β is the second weight; and tᵢ is the transmission time along the i-th link.

Preferably, α and β satisfy the following condition:

α/β>n·(Tₘᵢₙ−Tₘₐₓ)-Tₘₐₓ

wherein n is a preconfigured maximum number of hops; Tₘᵢₙ is the transmission time of a reference packet at a lowest admissible transmission rate; and Tₘₐₓ is the transmission time of a reference packet at a highest admissible transmission rate.

The transmission time of the i-th link can be calculated according to the following equation:

tᵢ(Rⱼ)=tₚ(Rⱼ)+t_{layers}+SIFS+t_{ack}(Rⱼ)+DIFS

wherein Rⱼ is the transmission rate of the i-th link, selected in a set of possible transmission rates; tₚ is the transmission time of a voice packet of size p; t_{layers} is the transmission time of physical and MAC portions of the voice packet; t_{ack} the transmission time of an Acknowledgment packet; SIFS is a Short Inter-Frame Space; and DIFS is a Distributed Inter-Frame Space.

All the links in said network may have the same values of α and β.

The network is preferably a Mobile Ad-hoc Network.

The network preferably includes at least a gateway for connection with a further network, and the possible paths may connect a node of the network with the gateway.

Preferably, the method further comprises computing in each node the set of possible paths towards other nodes of the network.

The transmission rates may be selected according to the IEEE 802.11 standard.

The invention also relates to a mobile network configured for VoIP connections, comprising a set of nodes suitable communication with each other through paths within said network, each path being associated with a number of hops between nodes and a transmission time of a reference voice packet, and each of said nodes comprising a processing unit configured to select a path among a set of possible paths towards another of said nodes based on the number of hops and the transmission time along the possible paths.

Preferably, the set of nodes comprises at least a gateway node configured to provide communication between other nodes of the network and an external network.

### BRIEF DESCRIPTION OF THE ANNEXED DRAWINGS

The invention will now be described, by way of example only, with reference to the enclosed figures of drawing, wherein:

FIGS. 1a and 1b show two examples of equipment of a mobile terminal in a hybrid network; and

FIG. 2 shows an example of a MANET network linked with a cellular network.

### DETAILED DESCRIPTION OF PREFERRED EMBODIMENTS OF THE INVENTION

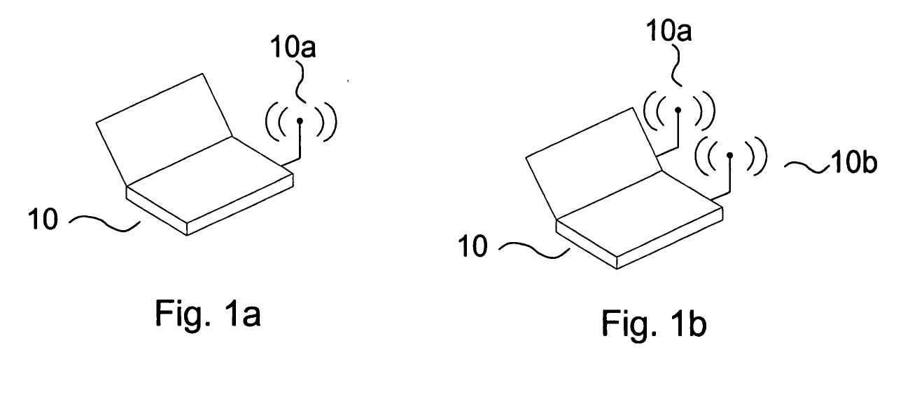

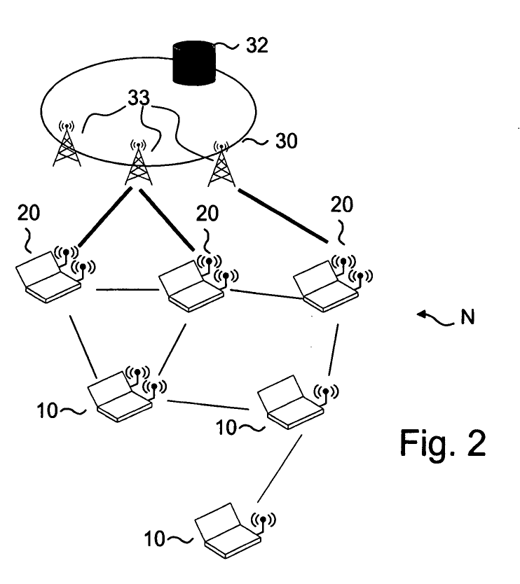

FIGS. 1a and 1b show, respectively, two examples of equipment of a mobile node (or terminal) 10 in a hybrid ad-hoc network, generally designated N in FIG. 2. Specifically, FIGS. 1a and 1b may refer, by way of example, to any of the mobile nodes designated with 10 in the rest of the description.

FIG. 2 depicts the general context of application considered herein, namely, an ad-hoc network N comprising a set of nodes, designated 10 and 20, wherein topological information on the network N is broadcast to all the nodes 10, 20 in the set.

The network N can be linked with an external network 30 with infrastructure. In the illustrative embodiment of FIG. 2, the network N is a Mobile Ad-hoc Network (MANET) and the external network 30 is a mobile-radio network (or “cellular network”) suitable to provide access to Internet. The mobile-radio network 30 comprises a server 32 and a plurality of radio stations 33.

A number of nodes 20 of the network N are adapted to perform a gateway function between the MANET N and the external network 30 and will be referred to as gateways 20. By means of this gateway function, mobile terminals in the MANET can instantiate VoIP connections with peers, in particular other terminals, located somewhere in the global Internet or even in the switched telephone network.

More to the point, the solution described herein preferably applies to a MANET with the following, exemplary characteristics:

as shown in FIGS. 1a and 1b, all the nodes of the MANET are equipped with a Wireless Local Area Network Interface (or “WLAN Interface”) 10a of a known type, in particular a “Wi-Fi” Interface as defined in the IEEE 802.11 set of standards, which enables direct delivery of data to other nodes in a transmission range. Each node is able to know which IEEE 802.11 transmission rate is used to transmit data frames to other nodes in the transmission range; moreover, each node may possibly be equipped with more than one WLAN interface 10a, for example for connections at different bit-rates;

as shown in FIG. 1b, some of the nodes of the MANET are also equipped, in addition to the above interface 10a, with a second radio interface, namely a Cellular Network Interface (or “CN Interface”) 10b of a known type. Some of these nodes can also have an active link towards the external network 30 by means of the CN interface 10b; these “hybrid” nodes are the above-mentioned gateways 20;

the MANET nodes that do not have an active link towards the external network 30 (nodes 10) communicate with hosts located in the Internet by means of a multi-hop connection to the gateways 20, through other nodes; the gateways are configured to bridge the flow to the other interface, relaying the traffic to the intended peer;

all nodes of the MANET run a routing protocol, preferably the OLSR protocol properly adapted, which calculates routes to other nodes using a value, named metric, assigned to the link between each node and nodes that are in its transmission range. In OLSR the status of the links is periodically broadcast in the

MANET by a subset of nodes, called MPR (MultiPoint Relays) nodes. Each node in the MANET uses an identifier, called primary address, to participate to OLSR protocol, by inserting this address into the OLSR “Originator Address” field of all the transmitted messages;

each node in the MANET uses a codec to encode and transmit voice (and then do decode the received signals), which uses a sampling time Tₛ and a voice packet size S. For example, the nodes may use the GSM-EFR codec, having Ts=20 ms and S=30 bytes.

Broadcast mechanism through MPRs allows to minimize the overhead of flooding messages in the network by reducing redundant retransmissions in the same region. Each node in the network selects its own set of MPR nodes, representing the set of nodes in its symmetric 1-hop neighborhood that may retransmit its messages. The neighbors of node N that are not in its MPR set receive and process broadcast messages but do not retransmit broadcast messages received from node N. The MPR set of a node is selected such that it covers (in terms of radio range) all symmetric strict 2-hop nodes. The MPR set of a node N, denoted as MPR(N), is therefore an arbitrary subset of the symmetric 1-hop neighborhood of N which satisfies the condition that every node in the symmetric strict 2-hop neighborhood of N must have a symmetric link towards MPR(N). The smaller a MPR set, the less control traffic overhead results from the routing protocol.

Using the MPR flooding mechanism, link-state information can be injected into the network using TC (Topology Control) messages: a node evaluates periodically if it is required to generate TC messages and, if so, which information is to be included in these TC messages.

TC messages are exchanged within the entire network with the purpose of populating the topology information base, so that information can be present in each node describing all destinations and (at least) a sufficient subset of links in order to provide least-hop paths to all destinations. In particular, a TC message is sent by a node in the network to declare a set of links, called “advertised link set”, which must include at least the links to all nodes of its MPR Selector set, i.e., the neighbors that have selected the sender node as a MPR.

Each node maintains a routing table that allows it to route data destined for the other nodes in the network. The routing table is based on the information contained in a local link information base and a topology set. Therefore, if any of these sets are changed, the routing table is recalculated to update the route information about each destination in the network. The route entries may be recorded in the routing table in the following format:

### 1. R_dest_addr R_next_addr R_dist R_iface_addr

### 2. R_dest_addr R_next_addr R_dist R_iface_addr

### 3. R_dest_addr R_next_addr R_dist R_iface_addr

Each entry in the table consists of R_dest_addr, R_next_addr, R_dist, and R_iface_addr. Such entry specifies that the node identified by R_dest_addr is estimated to be R_dist hops away from the local node, that the symmetric neighbor node with interface address R_next_addr is the next hop node in the route to R_dest_addr, and that this symmetric neighbor node is reachable through the local interface with the address R_iface_addr. Entries are recorded in the routing table for each destination in the network for which a route is known. All the destinations, for which a route is broken or only partially known, are not recorded in the table. The routing table is updated every time a change is detected.

As previously described, the bottleneck of such a system with respect to communications towards an external network is represented by the gateways, which have to support all the outgoing traffic generated within the MANET.

The Applicant has found that, in order to reduce the bottleneck problems at the gateways, or in other words in order to support the highest number of voice connections, a new metric function can be used, which minimizes the number of hops of each path and the delivery delay.

The new metric function is derived as follows.

A cost is associated with every link in the MANET. The cost wᵢ of the i-th link of the MANET between the generic MANET node A and the generic MANET node B is calculated as follows:

wᵢ=α+β·tᵢ; (1)

where:

α is the weight associated to the hop (link);

β is the weight associated to the latency; and

tᵢ is the time needed to transmit a reference packet of size S from node A to node B at a rate Rⱼ currently used from nodes A and B.

The rate Rⱼ is selected (on a link basis) in a set of possible values (R₁, . . . , Rₖ) provided in the considered version of the IEEE 802.11 standard. For example, in IEEE 802.11b the possible values of Rⱼ are 1, 2, 5.5 and 11 Mbit/s.

The time tᵢ is calculated with the following equation (which is a rearrangement of the equation previously described with reference to the document S. Garg and M. Kappes, in “Can I add a VoIP Call?”, Proceedings of IEEE ICC, Anchorage, 11-15 May 2003):

tᵢ(Rⱼ)=tₚ(Rⱼ)+t_{layers}+SIFS+t_{ack}(Rⱼ)+DIFS (2)

where tₚ is the transmission time of a voice packet of size p over 802.11, t_{layers} is the transmission time of physical and MAC portions of the packet, t_{ack} is the transmission time of the Acknowledgment packet and SIFS and DIFS are the Short and Distributed Inter-Frame

Space. Considering, for instance, the GSM-EFR voice codec, which generates MPDUs of 30 bytes every 20 ms, and a physical transmission rate of R=11 Mbps, we get tᵢ(R11)=530.5 μs.

The total cost of a path is therefore:

W=Σᵢwᵢ=Σᵢ(α+β·tᵢ) (3)

If α and β are the same for all the links, equation (3) becomes W=α·N+β·T, where N is the number of links (hops) in the path and T is the end-to-end latency of the path, i.e. the total time needed to deliver the packet over the path.

The two coefficients α and β are set so that the shortest path is always the first choice, but in case of multiple paths with minimum number of hops, the routing algorithms will prefer the path with minimum end-to-end delay.

In particular, the two coefficients α and β satisfy the following condition:

α/β>n·(Tₘᵢₙ−Tₘₐₓ)-Tₘₐₓ; (4)

where:

n is a preconfigured maximum number of hops between MANET nodes and gateways;

Tₘᵢₙ is the transmission time of a reference packet of size S (in bytes) when Rⱼ has the lowest rate value among those provided in the considered IEEE 802.11 standard, e.g. 1 Mbit/s for IEEE 802.11b, and is calculated with equation (2); and

Tₘₐₓ is the transmission time of a reference packet of size S (in bytes) when Rⱼ has the highest rate value among those provided in the considered version of the IEEE 802.11 standard, e.g. 11 Mbit/s for IEEE 802.11b, and is calculated with equation (2); the highest rate depends on the IEEE 802.11 version; for example, the highest rate is 1 Mbit/s for 802.11, 11 Mbit/s for 802.11b, 54 Mbit/s for 802.11a and 802.11g.

In equation (3), it is possible to vary the weights applied to the length of the path and the time delay, but the above constraint on α and β must be satisfied.

MANET nodes are preferably preconfigured with the same values of α, β, n and S. S corresponds to the smallest voice packet used to transmit voice and it is dependent from the used audio codec.

A possible set of values is:

S=30 bytes (GSM-EFR codec);

α=137,2;

β=1; and

n=3.

The different nodes of the MANET perform the following operations:
1) each node retrieves from its 802.11 interface the rate Rⱼ at which traffic is transmitted to each of its neighbor nodes; for example, values can be 1, 2, 5.5, 11 Mbit/s for IEEE 802.11b;
2) for each of its neighbour nodes, each node calculates the cost wᵢ of the associated link with equation (1), using Rⱼ to calculate tᵢ with equation (2);

3) each node inserts the calculated wᵢ in its announced Hello messages. Hello messages are emitted periodically and serve to inject topology information concerning local topology. Moreover, each MPR node inserts the calculated wᵢ also in its announced TC messages. TC messages are emitted periodically and serve to inject link-state information into the entire network, thus allowing nodes to continuously track global changes in the network.

Operations 1)-3) are executed every time a node must send a Hello message or a TC message to the MANET. Both types of messages are modified to carry the new metric: every entry containing the address of a node listed in the sent message is coupled with the correspondent cost calculated with equation (1).

Every time there is a change to its local link information base or to its topology set (or both), each node updates its own routing table by running the Dijkstra algorithm using the new metric as path costs.

Therefore, according to the present invention, the cost wᵢ is used instead of hop-count for path calculation in the routing protocol. If a node has multiple paths to choose among to send data traffic to the gateway, all having the same number of hops, it will choose the path that minimizes the transmission time. Condition of equation (3) assures that the node will always choose first the path with the minimum number of hops.

The solution of the present invention can be generalized to further routing protocols, properly adapted with the new metric. For example, instead of being based on the OLSR routing policy, the routing algorithm of the present invention may be based on other routing policies that attempt to find the path with the minimum number of hops, like the well known AODV and DSR. These algorithms differ in the amount of control traffic for establishing new connections, and in the ability to react to variations on the network topology. For instance, OLSR generates higher control traffic since each node periodically announces its presence to the other nodes with “Hello” packets. On the other hand, it always maintains valid routes to every destination. The other protocols, on the contrary, suffer some latency to instantiate a new route. Due to these characteristics, the routing protocols react in a different manner to network congestion.

The solution of the present invention can be also generalized to different physical rates of the 802.11 family, such as 802.11a and 802.11g, and other reference packet sizes.

The gateways nodes can be fixed nodes, i.e. they don't change their geographical location. The uplink interface on the gateways can be a wired interface.

Moreover, the solution of the present invention can be applied to hybrid MANETs connected to any type of external infrastructure network, and can be applied as well to any multi-rate radio transmission system.

Therefore, without prejudice to the underlying principles of the invention, the details and the embodiments may vary, also appreciably, with reference to what has been described by way of example only, without departing from the scope of the invention as defined by the annexed claims.

1-16. (canceled)

17. A method for routing voice over internet protocol traffic in a multi-hop mobile communication network, comprising selecting a path among a set of possible paths between two nodes of said network based on the number of hops and the transmission time of a reference voice packet along the possible paths.

18. The method of claim 17, wherein each of said possible paths comprises one or more links, each of said links connecting two neighbour nodes and having associated therewith a respective transmission rate, and wherein the transmission time along each possible path is a function of the transmission rates associated with the links comprising the path.

19. The method of claim 17, wherein selecting a path comprises assigning a cost to each of said possible paths, said cost being related to said number of hops and said transmission time through a first and a second weight, respectively.

20. The method of claim 19, comprising selecting the first and the second weight so that if the set of possible paths comprises a path with a lowest number of hops, the selected path is said path with the lowest number of hops.

21. The method of claim 19, comprising selecting the first and the second weight so that if the set of possible paths comprises two paths with a lowest number of hops, the selected path is the one of said two paths having the lowest transmission time.

22. The method of claim 19, wherein each of said possible paths comprises one or more links, each of said links connecting two neighbour nodes and having associated therewith a respective transmission rate; wherein the transmission time along each possible path is a function of the transmission rates associated with the links comprising the path; wherein each of said links is associated with an elementary cost related to the respective transmission time; and wherein the cost assigned to each of said possible paths is the sum of the elementary costs of the links of the path.

23. The method of claim 22, wherein said cost is expressed by the following equation:
W=Σᵢ(α+β·tᵢ)
wherein i is a number of links in the path; α is a first weight; β is a second weight; and tᵢ is transmission time along an i-th link.

24. The method of claim 23, wherein α and β satisfy the following condition:
α/β>n·(Tₘᵢₙ−Tₘₐₓ)-Tₘₐₓ
wherein n is a preconfigured maximum number of hops; Tₘᵢₙ is transmission time of a reference packet at a lowest admissible transmission rate; and Tₘₐₓ is transmission time of a reference packet at a highest admissible transmission rate.

25. The method of claim 18, wherein the transmission time of an i-th link is calculated according to the following equation:
tᵢ(Rⱼ)=tₚ(Rᵢ)+t_{layers}+SIFS+t_{ack}(Rⱼ)+DIFS
wherein Rⱼ is the transmission rate of an i-th link, selected in a set of possible transmission rates; tₚ is transmission time of a voice packet of a size p; t_{layers} is transmission time of a physical and MAC portions of the voice packet; t_{ack} is transmission time of an acknowledgment packet; SIFS is a short inter-frame space; and DIFS is a distributed inter-frame space.

26. The method of claim 23, wherein all the links in said network have the same values of ∀ and ∃.

27. The method of claim 17, wherein said network is a mobile ad-hoc network.

28. The method of claim 17, wherein said network comprises at least a gateway for connection with a further network, and wherein said possible paths connect a node of said network with said gateway.

29. The method of claim 17, further comprising computing in each node the set of possible paths toward other nodes of the network.

30. The method of claim 18, wherein said transmission rates are selected according to an IEEE 802.11 standard.

31. A mobile network configured for voice over internet protocol connections, comprising a set of nodes in suitable communication with each other through paths within said network, each path being associated with a number of hops between nodes and a transmission time of a reference voice packet, wherein each of said nodes comprises a processing unit configured to select a path among a set of possible paths toward another of said nodes based on said number of hops and said transmission time along the possible paths.

32. The mobile network of claim 31, wherein the set of nodes comprises at least a gateway node capable of being configured to provide communication between other nodes of the network and an external network.
